(19) United States
(12) Patent Application Publication
(10) Pub. No.: US 2015/0347250 A1
(43) Pub. Date: Dec. 3, 2015

(54) DATABASE MANAGEMENT SYSTEM FOR PROVIDING PARTIAL RE-SYNCHRONIZATION AND PARTIAL RE-SYNCHRONIZATION METHOD OF USING THE SAME

(71) Applicant: Altibase Corp., Seoul (KR)

(72) Inventors: Jun Young Kim, Seoul (KR); Jeong Seung Yu, Seoul (KR); Seung Won Lee, Seoul (KR); Jung Keun Kim, Gyeonggi-do (KR)

(21) Appl. No.: 14/609,097

(22) Filed: Jan. 29, 2015

(30) Foreign Application Priority Data
May 30, 2014 (KR) 2014-0066514

(51) Int. Cl. G06F 11/20

(52) U.S. Cl. CPC G06F 11/2082

(57) ABSTRACT

Provided is a database management system (DBMS). The DBMS synchronizes an active node with a standby node and detects a point of time when last synchronization is performed between the active node and the standby node. Then, after the DBMS performs page synchronization from the detected point of time of the last synchronization to a point at which a failover occurs in the active node, the DBMS performs partial log synchronization by receiving a log from the standby node after the point of time of the last synchronization until the active node is recovered.

### RELATED APPLICATION

This application claims the benefit of Korean Patent Application No. 10-2014-0066514, filed on May 30, 2014, in the Korean Intellectual Property Office, the disclosure of which is incorporated herein in its entirety by reference.

### BACKGROUND

1. Field

One or more embodiments of the present invention relate to data replication and synchronization in a database management system.

2. Description of the Related Art

A database management system (DBMS) is software that is a basis for providing various information technology (IT) application services. The DBMS needs to have high availability so as to provide a constant data service even in various failover situations. Therefore, the DBMS provides a database duplication function such as duplication into an active node and a standby node, so as to ensure a basic function, that is, stability, and provide a high availability service.

Database duplication is performed by providing a standby node (standby server) as well as an active node (main server) and, if a failover occurs in the active node, performing a transaction service in a standby node to ensure availability. Generally, database duplication is performed by transmitting a log of transactions, which is generated in an active node, and reproducing a transaction of the active node in a standby node so that data in the standby node is changed to be identical to data in the active node.

As an example of synchronizing two different databases, a method of copying a data file from an active node to a standby node is employed. Then, if a data file in the active node is changed, a change in the data file is notified of to the standby node, and the change is reflected in the standby node.

However, if a database is copied by using this method, a data file of the active node and a data file of the standby node may not be synchronized in real time.

Additionally, if a data file of the active node is changed, a high cost may be incurred to copy the changed data file to the standby node and reflect a change.

### SUMMARY

One or more embodiments of the present invention include a partial re-synchronization method performed to synchronize an active node with a standby node.

According to an embodiment of the present invention, the partial re-synchronization method is performed by sequentially performing page synchronization and log synchronization. By using such synchronization method, data may be synchronized at a low cost even when a failover occurs between a plurality of database management systems (DBMSs) that are performing physical replication.

According to an embodiment of the present invention, even when a failover occurs between a plurality of DBMSs that are performing physical replication by using the partial re-synchronization method, a seamless DBMS service may be provided to a user.

Additional aspects will be set forth in part in the description which follows and, in part, will be apparent from the description, or may be learned by practice of the presented embodiments.

According to one or more embodiments of the present invention, a database management system (DBMS) for providing partial re-synchronization includes: a log synchronization unit for asynchronously transmitting a log from a first node to a second node and performing a redo operation internally on a log received by the second node; a partial page synchronization unit for checking which data pages in the first node are affected due to log operations performed on a GAP part of the first node and receiving corresponding data pages from the second node and overwriting the affected data pages in the first node with the corresponding data pages of the second node; and a log re-synchronization unit, which is operated in the first node after a failed first node restarts, for comparing a sequence number of newly updated transaction log data in the second node to a sequence number of applying data pages in the first node and receiving the newly updated transaction log data whose update sequence number is greater than the sequence number of the applying data pages in the first node, wherein the first node acting as a master server is actively used to run the DBMS, while the second node acting as a slave server is in a standby node ready to take over if a failover occurs, and when the failed master server restarts, the first node performs partial page synchronization and log re-synchronization, wherein the GAP part represents a section from right after a point at which synchronization is performed last between the first node and the second node before a failover occurs in the first node to a point at which a log is recorded last in the first node before the failover occurs.

The partial page synchronization unit may determine that the data pages in the first node are affected only when the log operations performed on the GAP part of the first node make an alteration to any of the data pages.

The partial page synchronization unit may determine that the data pages in the first node are unaffected when the log operations performed on the GAP part of the first node make no alteration to any of the data pages.

According to one or more embodiments of the present invention, a database management system (DBMS) for providing partial re-synchronization includes: a log synchronization unit for asynchronously transmitting a log from an active node to a standby node; a search unit for searching for a point at which synchronization is performed last between the active node and the standby node if a failover occurs in the active node; a log checking unit for checking whether at least a log, which is recorded after the point at which the synchronization is performed last in the active node, is present in the active node when the failover occurs; a partial page synchronization unit for checking which data pages in the active node are affected due to a log operation performed on the log that is checked by the log checking unit and overwriting the affected data pages in the active node with corresponding data pages in the standby node after the failed active node restarts; and a log re-synchronization unit, which is operated in the active node after the failed active node restarts, for comparing a sequence number of newly updated transaction log data in the standby node to a sequence number of applying data pages in the active node and receiving the newly updated transaction log data whose sequence number is greater than the sequence number of the applying data pages in the active node.

The active node acting as a master server may be actively used to run the DBMS, while the standby node acting as a slave server is in the standby node ready to take over if a failover occurs, and when the failed active node restarts, the active node performs log re-synchronization in the log re-synchronization unit.

The partial page synchronization unit may determine that the data pages in the first node are affected only when the log operations performed on the log that is checked by the log checking unit make an alteration to any of the data pages.

The active node acting as a master server may be actively used to run the DBMS, while the standby node acting as a slave server is ready to take over if a failure occurs, wherein the partial page synchronization unit overwrites the affected data pages in the active node with the corresponding data pages in the standby node after the failed active node restarts.

The active node may be a master server for performing a DBMS management service until before a point of time when the failover occurs, and is a server for processing a requirement of a client.

The standby node may be a server for obtaining backup of data of the active node via communication with the active node and ensures availability by performing a transaction service in the standby node if a failover occurs in the active node.

According to one or more embodiments of the present invention, a database management system (DBMS) for providing partial re-synchronization includes: an active node for communicating with a client and processing a requirement of the client; a standby node for asynchronously obtaining backup of data of the active node via communication with the active node and performing a transaction service instead of the active node if a failover occurs in the active node; a log synchronization unit that is implemented in a standby node and performs a redo operation by asynchronously receiving a log from the active node; a partial page synchronizing unit that is implemented in the active node and overwrites data pages affected by log operations committed during a GAP part with corresponding data pages from the standby node; and a log re-synchronization unit, which is operated in the active node after a failed active node restarts, for comparing a sequence number of newly updated transaction log data in the standby node to a sequence number of applying data pages in the active node and receiving, in the active node, the newly updated transaction log data whose update sequence number is greater than the sequence number of the applying data pages, wherein the active node acting as a master server is actively used to run the DBMS, while the standby node acting as a slave server is ready to take over if a failure occurs, and the partial page synchronizing unit and the log re-synchronization unit are configured to operate after the failed active node restarts.

The partial page synchronization unit may determine that the data pages in the active node are affected only when the log operations performed on the GAP part of the active node make an alteration to any of the data pages.

According to one or more embodiments of the present invention, a method of partially synchronizing a log, which is performed by a database management system (DBMS) includes: asynchronously transmitting a log from an active node to a standby node and performing a redo operation internally on a log received by the second node, which is performed by a log synchronization unit; checking whether at least a log, which is recorded after a point at which the synchronization is performed last in the active node, is present when a failover occurs; replacing data pages affected by log operations done to the at least a log in the active node with corresponding data pages from the standby node; comparing a sequence number of newly updated transaction log data in the standby node to a sequence number of applying data pages in the active node, which is performed by a log re-synchronization unit, wherein the log re-synchronization unit is operated in the active node after the failed active node restarts; and receiving, in the active node, the newly updated transaction log data whose sequence number is greater than the sequence number of the applying data pages.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates an example of a duplicated configuration of a database management system (DBMS) according to an embodiment of the present invention;

FIG. 2 illustrates an example of performing log synchronization between an active node and a standby node, according to an embodiment of the present invention;

FIG. 3 illustrates an example in which a failover occurs in the active node, shown in FIG. 2, when logs are stacked in the active node;

FIG. 4 illustrates a system in which a second server, which has operated as a slave server, operates as a master server;

FIG. 5 illustrates an example of performing re-synchronization between an active node and a standby node after a failover occurs according to an embodiment of the present invention;

FIG. 6 illustrates an internal configuration of a first node and a second node in a DBMS for providing partial re-synchronization, according to an embodiment of the present invention;

FIG. 7 is a diagram of an internal configuration of an active node of the DBMS for providing partial re-synchronization, according to an embodiment of the present invention;

FIG. 8 is a diagram of an internal configuration of an active node and a standby node in a DBMS for providing partial re-synchronization, according to an embodiment of the present invention;

FIG. 9 is a flowchart of partial re-synchronization, which is performed by the DBMS shown in FIG. 6, according to an embodiment of the present invention; and

FIG. 10 is a flowchart of re-synchronization of logs between an active node and a standby node in a DBMS, according to an embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The description, provided hereinafter, merely illustrates principles of the present invention. Therefore, those skilled in the art may implement the principles of the present invention and invent a wide variety of devices that are included in the concept and scope of the present invention, though not clearly described or illustrated herein. In addition, it needs to be understood that all conditional terms and embodiments, listed herein, are intended only for the purpose of helping to understand the concept of the present invention, and are clearly not limited to the embodiment and states that are particularly enumerated herein.

In addition, it may be understood that a detailed description that provides particular embodiments as well as the principles, perspectives, and embodiments of the present invention are intended to include structural and functional equivalents of the particular embodiments as well as the principles, perspectives, and embodiments of the present invention. Additionally, it may be understood that such equivalents include not only known equivalents but also equivalents that will be developed in the future, that is, all elements that are invented to perform the same functions regardless of structures.

Therefore, functions of various elements shown in the drawing that includes a processor or a functional block which is shown to have a concept similar to the processor may be provided by using not only dedicated hardware but also hardware with a capability to run appropriate software. If provided by the processor, the functions may be provided by a single dedicated processor, a single shared processor, or a plurality of individual processors, and some of the functions may be shared by such processors.

In addition, terms such as a processor, control, or terms that have a concept similar thereto shall not be interpreted to exclusively quote hardware with a capability to run software, and shall be understood to implicitly include digital signal processor (DSP) hardware, read-only memory (ROM) for storing software, random access memory (RAM), and non-volatile memory without limitation, as well as other well-known hardware.

Hereinafter, the present invention will be described in detail by explaining embodiments of the invention with reference to the attached drawings.

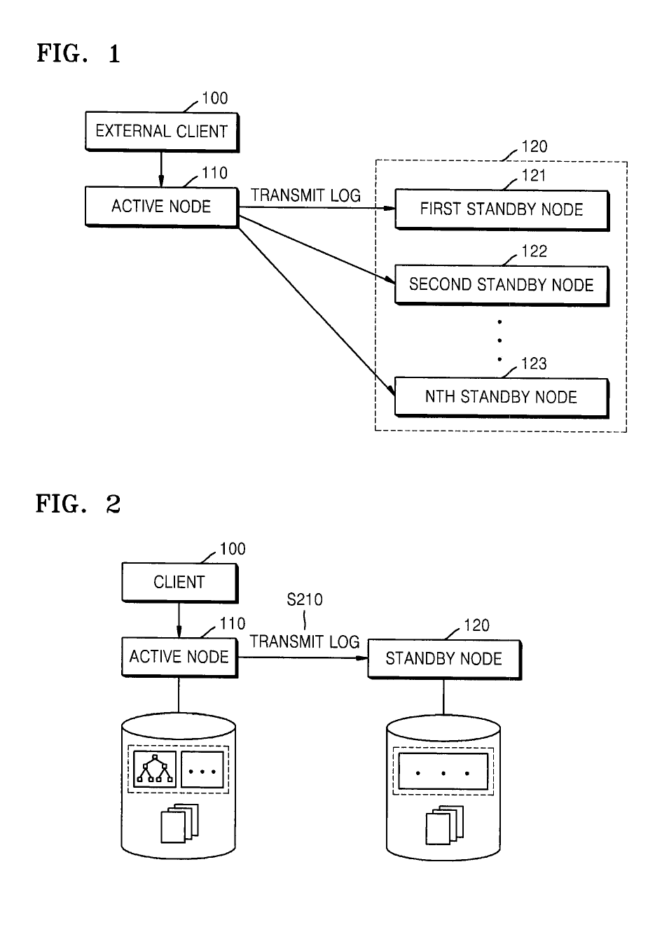

FIG. 1 illustrates an example of a duplicated configuration of a database management system (DBMS) according to an embodiment of the present invention.

In the current embodiment, the DBMS is duplicated into an active node 110 and a standby node 120, thus ensuring high availability of a database. According to an embodiment of the present invention, the active node 110 and the standby node 120 may be implemented in a relation of 1:n. Several backup servers may be implemented by making a plurality of standby nodes 121 through 123 correspond to one active node 100.

According to an embodiment of the present invention, the active node 110 is a server for processing a requirement of an external client 100 by communicating with the external client 100. The active node 110 is a primary server for performing a database management service. The active node 110 includes a log storage unit and a communication interface and is implemented to process a requirement of the external client 100 by communicating with the external client 100.

The standby node 120 is a second server for obtaining backup of data of the active node 110 via communication with the active node 110, without having to communicate with the external client 100. The active node 110 acting as a master server is actively used to run the DBMS, while the standby node 120 acting as a slave server is in a standby node ready to take over if a failover occurs in the active node 110.

When the active node 110 fails, the standby node 120 acts as a taken-over master server for ensuring that the database remains in a consistent state despite a system failure. The standby node 120 services the external client 100, only in case of a failure on the active node.

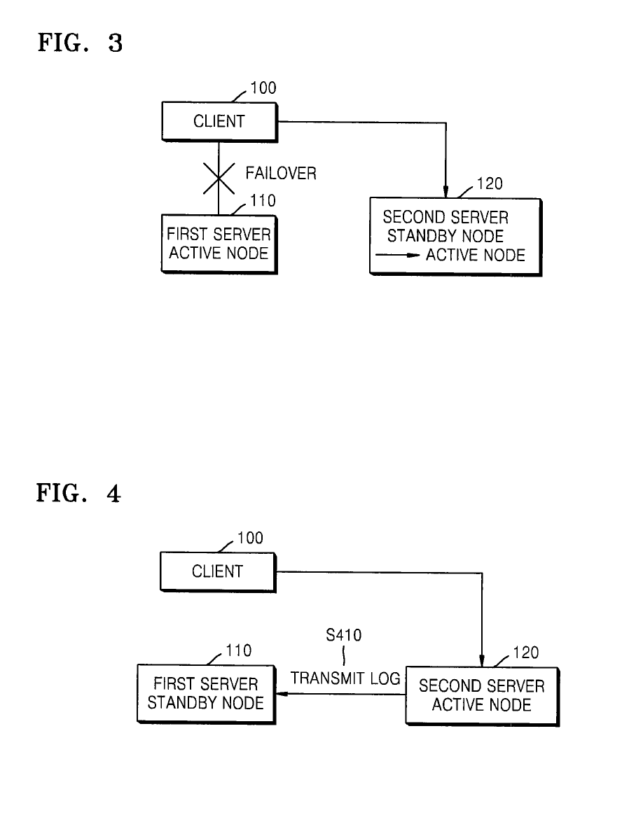

Referring to FIG. 3, if a failover occurs at the active node 110, the standby node 120 may operate as the taken-over master server for performing a database management service instead of the active node 110.

FIG. 2 illustrates an example of performing log synchronization (in S210) between the active node 110 and the standby node 120, according to an embodiment of the present invention. For convenience of description, it is assumed that one active node 110 and one standby node 120 are present. Additionally, it is assumed that the active node 110 and the standby node 120 asynchronously match data based on a log.

* Log synchronization process

The DBMS that includes the active node 110 and the standby node 120 performs logging for data change so as to ensure database stability. Logging is a basic DBMS function which is performed by recording insertion/deletion/modification of data in a stable storage such as a disk in real-time, so as to recover the database to a last database state by using recorded data in the case of a failover.

Referring to FIG. 2, the active node 110 records update logs that are generated when a requirement of the client 100 is processed, and the standby node 120 receives the update logs recorded by the active node 110 and performs a redo operation internally.

In this case, the active node 110 provides a function of recording and accessing the update logs and generates and manages a log index to quickly access the update logs.

The standby node 120 records information of the update log received from the active node 100 and generates and manages a log index so as to search for and change the recorded information of the update log.

In a process of the log synchronization shown in FIG. 2, a log may be transmitted between the active node 110 and the standby node 120 without bottleneck. However, if a network state is poor or if the active node 110 is in a busy state, logs that were not transmitted from the active node 110 to the standby node 120 may be stacked. FIGS. 3 and 4 show an example in which a failover occurs.

FIG. 3 illustrates an example in which a failover occurs in the active node 110, shown in FIG. 2, when logs are stacked in the active node 100.

When a failover occurs in a first server 110 that functions as the active node 110 shown in FIG. 2, the client 100 accesses a second server 120 that functions as the standby node 120 shown in FIG. 2. When a failover occurs in the first server 110, the second server 120 stops functioning as a standby node and operates as the taken-over active node.

In this case, the second server 120 may dismiss update logs that are being stacked in the first server 110 and are not transmitted yet to the second server 120, and operate as the taken-over active node from a moment when the client 100 accesses the second server 120.

FIG. 4 illustrates a system when the second server 120, which has operated as a standby node, operates as the taken-over active node.

When a failover occurs, a manager operates the second server 120 as the taken-over active node, and operates the first server 110 as the taken-over standby node. A requirement of the client 100 is transmitted to and processed by the taken-over active node 120. The second server 120 stores update logs, which are generated in a process of processing the requirement of the client 100, in the second server 120, and then, transmits the update logs to the first server 110 that operates as the taken-over standby server in S410. The first server 100 receives the transmitted update logs and performs a redo operation internally.

As shown in a process shown in FIGS. 3 and 4, if a function of the second server 120 is changed from a standby node to the taken-over active node, update log data, which was not transmitted yet from the first server 110 to the second server 120 when a failover occurs, may not be synchronized.

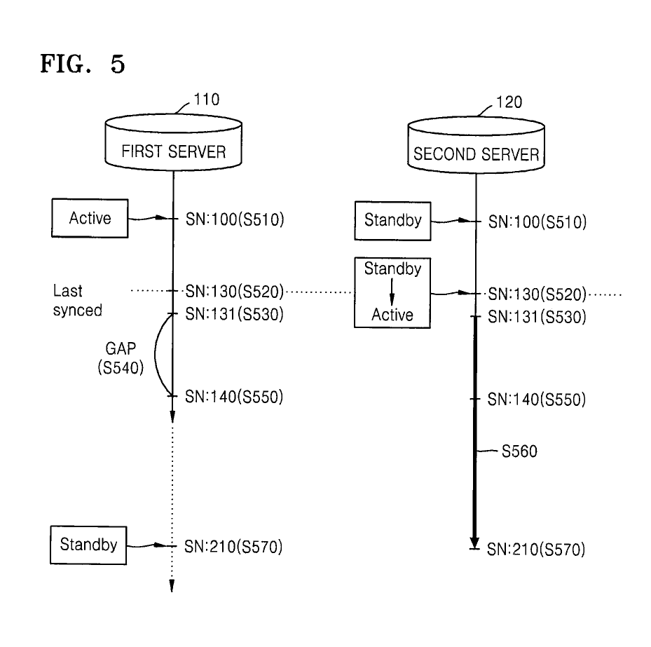

Referring to FIG. 5, log synchronization is as follows:

Initially, the first server 110 is implemented as an active node or a master server and the second server 120 is implemented as a standby node or a slave server. Then, logs that include up to a sequence number (SN) 140 (in S550) are recorded in the first server 110 before a failover occurs in the first server 110.

However, a situation in which about 10 logs recorded in the first server 110 are not be transmitted to the second server 120 may occur due to a system failure or an unexpected network state in the first server 110.

In this case, the second server 120 is in a standby mode ready to take over if there is an operating system or hardware failure involving the first server 110.

In detail, logs that include up to an SN 140 (in S550) are recorded in the first server 110, but the second server 120 has only received logs that include up to an SN 130 (in S520). If a failover occurs in this situation, the second server 120 functions as the taken-over active node right after a point of time when the second server 120 is last synchronized with the first server 110 (in S520). When the failed first server 110 restarts, the second server 120 is in a state of recording logs that include up to an SN 210 (in S570).

Then, the failed first server 110 starts to check which data pages in the first server 110 are affected due to log operations or log transactions committed in the GAP(S540) segment, and it overwrites the affected data pages in the first server 110 with the corresponding data pages of the second node 120, which has been operated as the taken-over active node.

Even after the failover is resolved, when the failed first server 110 is re-operated, the first server 110 does not immediately operate as an active node and starts to operate as a standby node. According to an embodiment of the present invention, after a failover is resolved, in a process when the first server 110 is driven as a standby node, partial re-synchronization is performed. According to an embodiment of the present invention, partial page synchronization and log re-synchronization are sequentially performed to recover a consistent database state in case of a system failure.

FIG. 5 illustrates an example of performing partial page synchronization to synchronize the first server 110 with the second server 120, according to an embodiment of the present invention.

A process of performing partial page synchronization is as follows:

It is determined whether a GAP segment (in S540) is present in the first server 110, wherein the GAP segment corresponds to a log segment from an SN 131 (in S530), right after a point at which last synchronization is performed to an SN 140 at which a log is recorded last before a failover occurs. In this case, the GAP segment (S540) of the first server 110, which is driven as the taken-over standby node, does not match the GAP segment (S540) of the second server 120, which is driven as the taken-over active node.

Accordingly, if the GAP segment (S540) is present, partial page synchronization is performed. According to an embodiment of the present invention, a list of pages with respect to the GAP segment (S540) of the first server 110 is generated, and then, pages corresponding to the pages in the list are received from the second server 120 and are overwritten to pages in the first server 110.

After partial page synchronization is performed on the GAP segment (S540) of the first server 110, the second server 120 transmits to the first server 110 (S560) logs that are recorded in the second server 120 from a point of an SN 131 (S530), which is after a point of SN 130 at which last synchronization is performed (in S520), to a point of an SN 210 (S570), which is right before the first server 110 returns to the active node.

Through this process, any change, which occurs in the GAP segment (S540) of the first server 110 in which a failover occurs, may be invalidated. In other words, after a recent page list that corresponds to a page list with respect to the GAP segment (S540) of the first server 110 is received from the second server 120, a transaction log that is newly generated from the second server 120 is sequentially received and reflected in the first server 110.

Work that is performed for each page is recorded in the transaction log received from the second server 120. Accordingly, since work with respect to the page list, which is received by the first server 110 from the second server 120 and overwritten, is recorded in the transaction log, even when the first server 110 sequentially receives the transaction log, the first server 110 may skip a part of a transaction log, in which work is already performed. In other words, since a recent page is already received, existing changes may not have to be further reflected. With regard to a page to which a recent page is not overwritten, a transaction log is sequentially received and reflected.

For this, the failed first node restarts after the failover and compares the sequence number of newly updated transaction log data in the second node to the sequence number of applying data pages in the first node and receives the newly updated transaction log data whose update sequence number is greater than the sequence number of applying data pages in the first node.

According to an embodiment of the present invention, if a log operation performed on the GAP segment (S540) is a data manipulation language (DML) log operation such as insert, delete, or update, data corresponding to the GAP segment (S540) the affected first node pages are overwritten with corresponding data pages in the second node. On the contrary, if the log operation is a DML log operation such as select, additional processing is not performed.

In an environment shown in FIG. 5, a table having a schema as shown below is assumed.

table table1 (col1 int, col2 int)

SNs increase according to elapsed time as follows:

An SN at which last synchronization is performed: 130 (S520)

Log of the first server 110 that functioned as an active node (last active server): 131(S530)

Gap SN(S540): 131˜140

It is assumed that a DML operation shown below is performed at the SN 130 (S520) of the first server 110 that is an active server. It is also assumed that a record shown below is recorded as a part of Page 20.

insert into table1 (1, 1);

It is assumed that a corresponding page (Page 20) is touched last at an SN 120. In this case, Page 20 of both of the first server and the second server 120 may be shown as follows:

Before [SN:120, Table1, . . . ]

After [SN:130, Table1, Record(1,1), . . . ]

It is assumed that a DML operation is performed at the SN 131 (S530) of the first server 110 that is an active server, as shown below.

update table1 set col2=7 where coil=1;

This record is recorded as a part of Page 20. Page 20 of the first server 110 may be shown as follows, but the page 20 of the second 120 is not changed:

Before [SN:130, Table1, Record(1,1), . . . ]

After [SN:131, Table1, Record(1,7), . . . ]

It is assumed that an DML operation is performed at the second server 120 that operated as a standby server and is changed to an active server, as shown below.

update table1 set col2 =col2+5 where coil=1;

This record shown above is recorded as a part of Page 20. However, since the second server 120 is not aware of the DML operation at the SN 131 (S530) performed by the first server 110, a value of col2 is calculated as 6, which is obtained by adding 5 to 1 that is a previous value. Accordingly, Page 20 of the second server 120 may be shown as follows:

Before [SN:130, Table1, Record(1,1), . . . ]

After [SN:137, Table1, Record(1,6), . . . ]

As described above, details about Page 20 are different between the first server 110 and the second server 120. Then, while a failover that occurred at the first server 110 is resolved, the first server 110 receives Page 20 by using the logged information at the SN 131 (S530) in the GAP segment (S540). Then, the first server 110 receives all logs that are generated after the SN 131 (S530) produced by the second server and sequentially reflects the logs in the first server 110. When the first server 110 receives and reflects a log at the SN 137 in Page 20 produced by the second server, SNs of the first server 110 are compared to SNs of the second server 120 so as to change Page 20.

Then, since 137 is recorded to an SN, the first server 110 applies reflecting of the log at SN 137 in Page 20 produced by the second server.

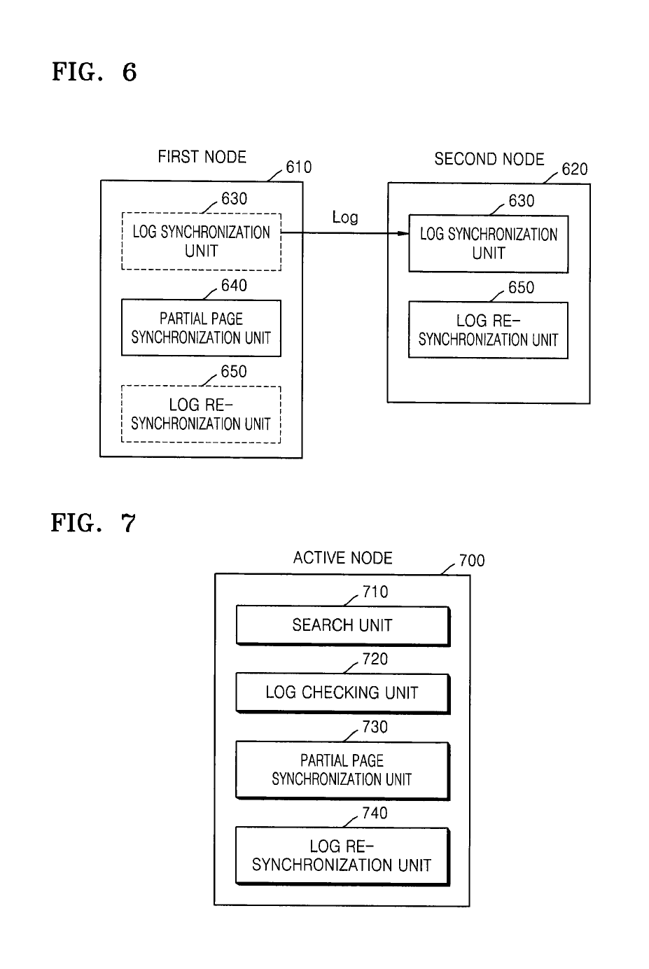

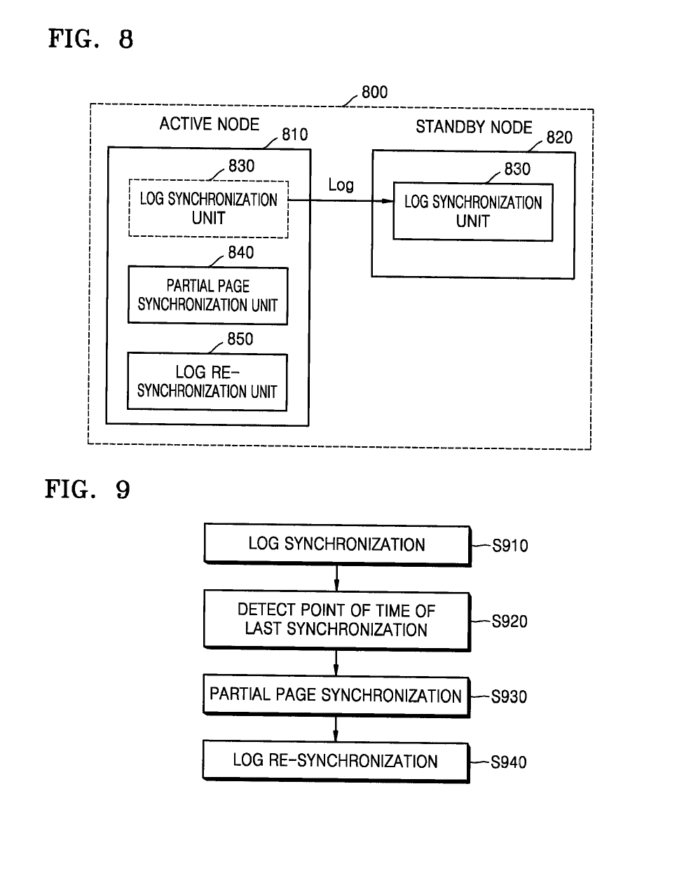

FIG. 6 illustrates an internal configuration of a first node 610 and a second node 620 in a DBMS for providing partial re-synchronization, according to an embodiment of the present invention. FIG. 9 is a flowchart of performing partial re-synchronization, which is performed by the DBMS shown in FIG. 6, according to an embodiment of the present invention.

Hereinafter, referring to FIGS. 5, 6, and 9, partial re-synchronization in the DBMS is described.

In operation S910, log synchronization is performed by the DBMS, shown in FIG.

6, via a log synchronization unit 630. In operation S920, a point of time of last synchronization is detected. In operation S930, partial page synchronization is performed from the detected point of time of the last synchronization to a point at which a failover occurs at an active node via a page synchronization unit 640. Then, in operation 940, synchronization is performed via a log re-synchronization unit 650. Referring to FIG. 5, this is described as follows:

The DBMS includes the first node 610 functioning as an active node and the second node 620 functioning as a standby node.

The first node 610 includes the log synchronization unit 630, the partial page synchronization unit 640, and the log re-synchronization unit 650. The second node 620 includes a log synchronization unit 630 and the log re-synchronization unit 650.

The first node 610 asynchronously transmits a log to the second node 620 via the log synchronization unit 630. The log synchronization unit 630 in the second node 620 is implemented to perform a redo operation internally on the log received from the first node 610.

Referring to an embodiment described with reference to FIG. 5, the first node 610 is implemented in the form of the first server 110 shown in FIG. 5, and the second node 620 is implemented in the form of the second server 120 shown in FIG. 5. The log synchronization unit 630 synchronizes the first server 110 shown in FIG. 5 with the second server 120 shown in FIG. 5. According to an embodiment described with reference to FIG. 5, a point at which last synchronization is performed is the SN 130 (S520).

Referring back to FIG. 6, the partial page synchronization unit 640 checks a log operation performed on the GAP segment S540, shown in PG. 5, of the first node 610. Then, partial page synchronization is performed by receiving from the second node 620 and overwriting a page with respect to a log on which at least a log operation is performed on the GAP segment (S540) shown in FIG. 5.

In this case, if the performed log operation is a DML log operation such as insert, delete, or update, data corresponding to the GAP segment (S540) the affected first node pages are overwritten with corresponding data pages in the second node. On the contrary, if the log operation is a DML log operation such as select, additional processing is not performed.

After log synchronization and partial page synchronization are performed, the first node 610 receives a log that is generated from a point of time after a point of time when synchronization between the first node 610 and the second node 620 is performed last in S520, shown in FIG. 5, before a failover occurs in the first node 610 to a point of time when the failover in the first node 610 is resolved, via the log re-synchronization unit 650.

According to an embodiment of the present invention, data is synchronized between the first node 610 and the second node 620 through a process described above.

FIG. 7 is a diagram of an internal configuration of an active node 700 in a DBMS for providing partial re-synchronization, according to an embodiment of the present invention.

The active node 700 includes a search unit 710, a log checking unit 720, a partial page synchronization unit 730, and a log re-synchronization unit 740.

The active node 700 asynchronously transmits a log to a standby node so as to be synchronized with the standby node. If a failover occurs in the active node 700, the search unit 710 searches for a point at which the active node 700 is last synchronized with the standby node.

Then, the log checking unit 720 in the active node 700 checks if at least a log recorded in the active node 700 is present after the point at which the active node 700 is last synchronized with the standby node, which is found by the search unit 710.

The partial page synchronization unit 730 checks if at least a log operation is performed on the log checked by the log checking unit 720. If a log operation is performed on the log, the partial page synchronization unit 730 checks which data pages in the active node are affected due to a log operation performed on the log that is checked by the log checking unit 720 and overwriting the affected data pages in the active node with the corresponding data pages in the standby node after the failed active node restarts.

FIG. 8 is a diagram of an internal configuration of an active node 810 and a standby node 820 in a DBMS 800 for providing log re-synchronization, according to an embodiment of the present invention.

The DBMS 800 for providing log re-synchronization includes the active node 810 and the standby node 820. The DBMS 800 for providing log re-synchronization asynchronously performs log synchronization between the active node 810 and the standby node 820 via a log synchronization unit 830.

If a failover occurs in the active node 810, the standby node 820 functions as an active node right after the failover occurs and generates a log by itself.

If the failover in the active node 810 is resolved, the active node 810 performs partial page synchronization on the GAP segment S540, shown in FIG. 5, via a partial page synchronization unit 840. Then, a log re-synchronization unit 850 performs re-synchronization by receiving the log that is generated by standby node 820 through the log synchronization unit 830 in the standby node 820.

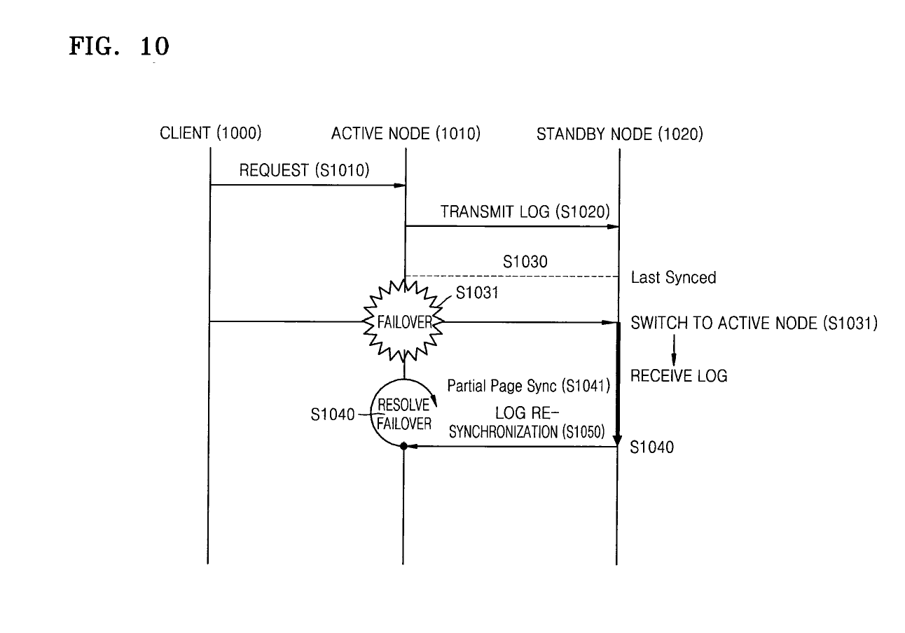

FIG. 10 is a flowchart of re-synchronization of logs between an active node 1010 and a standby node 1020 in a DBMS, according to an embodiment of the present invention.

The active node 1010 receives a service request (in operation S1010) from a client 1000. Then, in operation S1020, the active node 1010 asynchronously transmits a log, generated while processing the service request received from the client 1000, to the standby node 1020. In this process, the standby node 1020 is asynchronously synchronized with the active node 1010.

If a failover occurs in the active node 1010 in operation S1031, the standby node 1020 is switched to function as an active node in operation S1031, and then, receives a log. If a failover is resolved in the active node 1010 in operation S1040, the active node 1010 performs partial page synchronization in operation S1041 and performs re-synchronization by receiving the log which is generated from a point of time at which last synchronization between the active node 1010 and the standby node 1020 is performed to a point of time at which the failover in the active node 1010 is resolved in operation S1040.

As described above, according to the one or more of the above embodiments of the present invention, the method of partial re-synchronization may synchronize data at a low cost even when a failover occurs between a plurality of DBMSs that are performing physical replication.

Additionally, even when a failover occurs between a plurality of DBMSs that are performing physical replication by using the method of partial re-synchronization, a seamless DBMS service may be provided to a user.

In addition, other embodiments of the present invention can also be implemented through computer-readable code/instructions in/on a medium, e.g., a computer-readable medium, to control at least one processing element to implement any above-described embodiment. The medium can correspond to any medium/media permitting the storage and/or transmission of the computer-readable code.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more embodiments of the present invention. The media may also be a distributed network, so that the computer-readable code is stored/transferred and executed in a distributed fashion. Furthermore, the processing element could include a processor or a computer processor, and processing elements may be distributed and/or included in a single device. Also, functional programs, codes, and code segments for accomplishing the present invention can be easily construed by programmers skilled in the art to which the present invention pertains.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A database management system (DBMS) for providing partial re-synchronization, the DBMS comprising:
a log synchronization unit for asynchronously transmitting a log from a first node to a second node and performing a redo operation internally on a log received by the second node;
a partial page synchronization unit for checking which data pages in the first node are affected due to log operations performed on a GAP part of the first node and receiving corresponding data pages from the second node and overwriting the affected data pages in the first node with the corresponding data pages of the second node; and
a log re-synchronization unit, which is operated in the first node after a failed first node restarts, for comparing a sequence number of newly updated transaction log data in the second node to a sequence number of applying data pages in the first node and receiving the newly updated transaction log data whose update sequence number is greater than the sequence number of the applying data pages in the first node, wherein the first node acting as a master server is actively used to run the DBMS, while the second node acting as a slave server is in a standby node ready to take over if a failover occurs, and when the failed master server restarts, the first node performs partial page synchronization and log re-synchronization,
wherein the GAP part represents a section from right after a point at which synchronization is performed last between the first node and the second node before a failover occurs in the first node to a point at which a log is recorded last in the first node before the failover occurs.

2. The DBMS of claim 1, wherein the partial page synchronization unit determines that the data pages in the first node are affected only when the log operations performed on the GAP part of the first node make an alteration to any of the data pages.

3. The DBMS of claim 1, wherein the partial page synchronization unit determines that the data pages in the first node are unaffected when the log operations performed on the GAP part of the first node make no alteration to any of the data pages.

4. A database management system (DBMS) for providing partial re-synchronization, the DBMS comprising:
a log synchronization unit for asynchronously transmitting a log from an active node to a standby node;
a search unit for searching for a point at which synchronization is performed last between the active node and the standby node if a failover occurs in the active node;
a log checking unit for checking whether at least a log, which is recorded after the point at which the synchronization is performed last in the active node, is present in the active node when the failover occurs;
a partial page synchronization unit for checking which data pages in the active node are affected due to a log operation performed on the log that is checked by the log checking unit and overwriting the affected data pages in the active node with corresponding data pages in the standby node after the failed active node restarts; and
a log re-synchronization unit, which is operated in the active node after the failed active node restarts, for comparing a sequence number of newly updated transaction log data in the standby node to a sequence number of applying data pages in the active node and receiving the newly updated transaction log data whose sequence number is greater than the sequence number of the applying data pages in the active node.

5. The DBMS of claim 4, wherein the active node acting as a master server is actively used to run the DBMS, while the standby node acting as a slave server is in the standby node ready to take over if a failover occurs, and when the failed active node restarts, the active node performs log re-synchronization in the log re-synchronization unit.

6. The DBMS of claim 4, wherein the partial page synchronization unit determines that the data pages in the first node are affected only when the log operations performed on the log that is checked by the log checking unit make an alteration to any of the data pages.

7. The DBMS of claim 4, wherein the active node acting as a master server is actively used to run the DBMS, while the standby node acting as a slave server is ready to take over if a failure occurs,
wherein the partial page synchronization unit overwrites the affected data pages in the active node with the corresponding data pages in the standby node after the failed active node restarts.

8. The DBMS of claim 4, wherein the active node is a master server for performing a DBMS management service until before a point of time when the failover occurs, and is a server for processing a requirement of a client.

9. The DBMS of claim 4, wherein the standby node is a server for obtaining backup of data of the active node via communication with the active node and ensures availability by performing a transaction service in the standby node if a failover occurs in the active node.

10. A database management system (DBMS) for providing partial re-synchronization, the DBMS comprising:
an active node for communicating with a client and processing a requirement of the client;
a standby node for asynchronously obtaining backup of data of the active node via communication with the active node and performing a transaction service instead of the active node if a failover occurs in the active node;
a log synchronization unit that is implemented in a standby node and performs a redo operation by asynchronously receiving a log from the active node;
a partial page synchronizing unit that is implemented in the active node and overwrites data pages affected by log operations committed during a GAP part with corresponding data pages from the standby node ; and
a log re-synchronization unit, which is operated in the active node after a failed active node restarts, for comparing a sequence number of newly updated transaction log data in the standby node to a sequence number of applying data pages in the active node and receiving, in the active node, the newly updated transaction log data whose update sequence number is greater than the sequence number of the applying data pages.
wherein the active node acting as a master server is actively used to run the DBMS, while the standby node acting as a slave server is ready to take over if a failure occurs, and the partial page synchronizing unit and the log re-synchronization unit are configured to operate after the failed active node restarts.

11. The DBMS of claim 9, wherein the partial page synchronization unit determines that the data pages in the active node are affected only when the log operations performed on the GAP part of the active node make an alteration to any of the data pages.

12. A method of partially synchronizing a log, which is performed by a database management system (DBMS), the method comprising:
asynchronously transmitting a log from an active node to a standby node and performing a redo operation internally on a log received by the second node, which is performed by a log synchronization unit;
checking whether at least a log, which is recorded after a point at which the synchronization is performed last in the active node, is present when a failover occurs;
replacing data pages affected by log operations done to the at least a log in the active node with corresponding data pages from the standby node;
comparing a sequence number of newly updated transaction log data in the standby node to a sequence number of applying data pages in the active node, which is performed by a log re-synchronization unit, wherein the log re-synchronization unit is operated in the active node after the failed active node restarts; and
receiving, in the active node, the newly updated transaction log data whose sequence number is greater than the sequence number of the applying data pages.
